(19) United States
(12) Patent Application Publication
(10) Pub. No.: US 2017/0097066 A1
(43) Pub. Date: Apr. 6, 2017

(54) POWERSHIFT TRANSMISSION FOR CONSTRUCTION MACHINERY

(71) Applicant: ZF Friedrichshafen AG, Friedrichshafen (DE)

(72) Inventor: Norman REGENSCHEIT, Meckenbeuren (DE)

(21) Appl. No.: 15/279,711

(22) Filed: Sep. 29, 2016

(30) Foreign Application Priority Data
Oct. 1, 2015 (DE) 10 2015 219 000.5

(51) Int. Cl. F16H 3/093; F16H 3/08

(52) U.S. Cl. CPC F16H 3/093; F16H 3/08; F16H 2003/0818

(57) ABSTRACT

A powershift transmission, particularly for a construction machine such as backhoes or telehandlers, includes a mechanical power path and a hydrodynamic power path. The first, second and third gears can be engaged by way of the hydrodynamic torque converter (1) while the fourth, fifth and sixth gears can be engaged without the hydrodynamic torque converter (1). For this, the input shaft (6) is connected to the turbine (14) and the driveshaft (7) can be directly connected to the drive engine. The driveshaft (7) is located inside the input shaft (6).

This application claims priority from German patent application serial no. 10 2015 219 000.5 filed Oct. 1, 2015.

### FIELD OF THE INVENTION

The invention relates to a powershift transmission with several shiftable gears and with a hydrodynamic and a mechanical power path for construction machines, in particular backhoes or telehandlers.

### BACKGROUND OF THE INVENTION

The structural space available, in particular the distance between the driveshaft and the drive output shaft and thus the depth of the transmission, is limited. In addition, different axis distances between the transmission input shaft and the transmission output shaft should be possible. For that reason powershift transmissions of the type concerned have shafts at a distance apart from one another which preferably have only a single clutch, in order to be able to produce a compact transmission.

EP 1 329 648 B1 discloses a powershift transmission with a hydrodynamic and an optional mechanical power path, in which the input shaft is connected to a fixed wheel and is in the form of a hollow shaft, and the driveshaft passes through the input shaft and can be connected to an auxiliary power take-off. Furthermore, the input shaft is also connected to an outer disk carrier of a clutch in a rotationally fixed manner.

U.S. Pat. No. 6,513,399 B2 discloses a powershift transmission in which the driveshaft is connected to a pump wheel of a hydrodynamic torque converter and is also connected to an outer disk carrier of a clutch, and drives an auxiliary power take-off. The input shaft is in the form of a hollow shaft and is connected to the turbine wheel of the hydrodynamic torque converter rotationally fixed to a fixed wheel. In order to be able to shift the gears, two clutches have to be arranged on the shafts a distance apart, and for that reason the depth of the transmission has to be made greater such that it is not suitable for a telehandler.

### SUMMARY OF THE INVENTION

The purpose of the present invention is to provide a powershift transmission for construction machines, in particular for backhoes or telehandlers, which has a hydrodynamic power path and a mechanical power path and is of compact structure. In this context mechanical power path means that the drive output of the transmission can be connected to the drive engine independently of the function of the hydrodynamic torque converter.

This objective is achieved with a powershift transmission of the type concerned which also incorporates the characterizing features specified in the principal claim.

According to the invention, the powershift transmission comprises a hydrodynamic torque converter with a turbine and a pump, wherein the pump is in rotationally fixed connection with a driveshaft and this driveshaft can be connected to a drive engine such as a diesel internal combustion engine. The turbine of the hydrodynamic torque converter is connected in a rotationally fixed manner to an input shaft and a fixed wheel is also connected to the input shaft in a rotationally fixed manner. The input shaft is in the form of a hollow shaft and the driveshaft passes through the hollow shaft and is also connected in a rotationally fixed manner to a fixed wheel. The fixed wheel which is connected in a rotationally fixed manner to the input shaft is located between the hydrodynamic torque converter and the fixed wheel connected in a rotationally fixed manner to the driveshaft. Thus, the hydrodynamic torque converter and the two fixed wheels are arranged coaxially with one another. This makes it possible to arranged the shafts farther apart, with their shifting clutches and gearwheels, in such manner that a transmission of compact depth is obtained.

### BRIEF DESCRIPTION OF THE DRAWINGS

Other features emerge from the description of the figures.

The figures show:

FIG. 1: A powershift transmission without a shifting clutch on the input shaft;

FIG. 2: A powershift transmission with a clutch for a reversing gear on the input shaft;

FIG. 3: The arrangement of the gearwheels of the powershift transmission shown in FIG. 2;

FIG. 4: A powershift transmission with a clutch for the forward gear on the input shaft;

FIG. 5: The arrangement of the gearwheels of the powershift transmission shown in FIG. 4;

FIG. 6: A powershift transmission with a clutch for driving in reverse on the input shaft; and

FIG. 7: The arrangement of the gearwheels of the powershift transmission shown in FIG. 6.

### DETAILED DESCRIPTION OF THE PREFERRED EMBODIMENTS

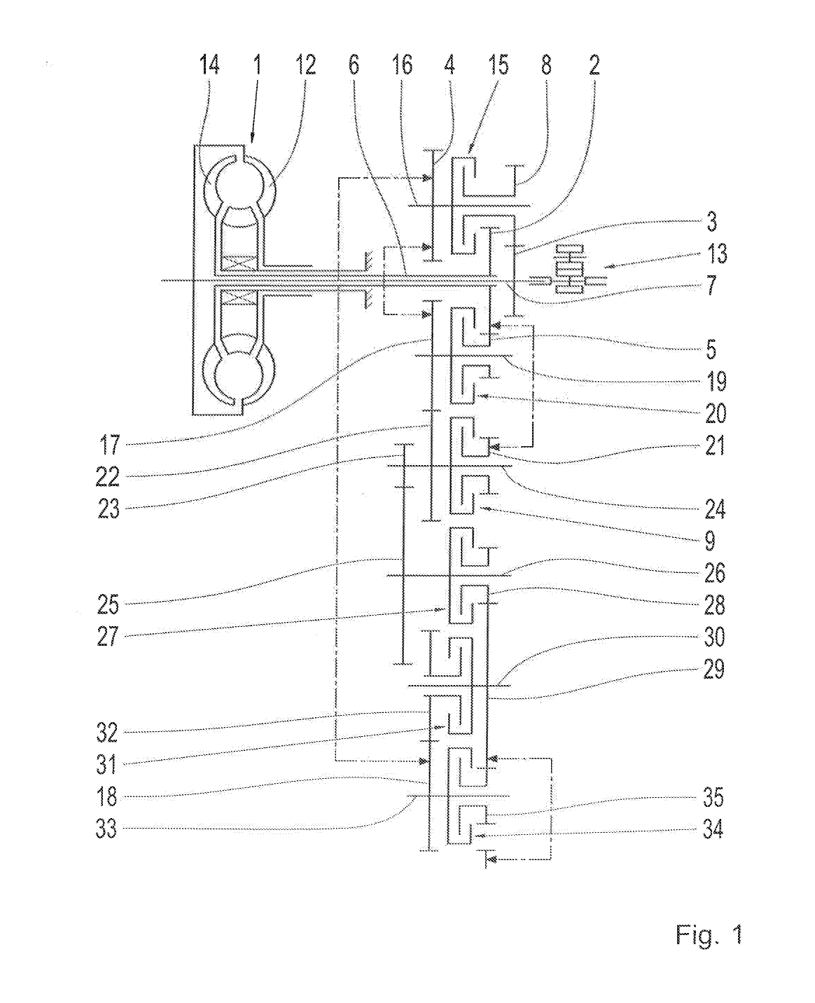

FIG. 1:

A drive engine (not shown), for example an internal combustion engine, drives the driveshaft 7, which is connected in a rotationally fixed manner on one side with the pump 12 of the hydrodynamic torque converter 1 and on the other side with the fixed wheel 3. Furthermore, the driveshaft 7 forms an auxiliary power take-off 13 opposite the hydrodynamic torque converter 1, which for example can be connected to the working pump of the construction machine. The turbine 14 of the hydrodynamic torque converter 1 is connected in a rotationally fixed manner to the input shaft 6, which is connected in a rotationally fixed manner to the fixed wheel 2. The input shaft 6 is in the form of a hollow shaft. The fixed wheel 3 meshes with the loose wheel 8, and the loose wheel 8 can be connected to the shaft 16 by means of the clutch formed as a fourth gear clutch 15. The shaft 16 is connected in a rotationally fixed manner to the fixed wheel 4. The fixed wheel 4 meshes on one side with the fixed wheel 17 and on the other side with the fixed wheel 18. The fixed wheel 17 is connected in a rotationally fixed manner to the shaft 19. By means of the clutch 20 for the reversing gear, the loose wheel 5 can be connected to the fixed wheel 17. The fixed wheel 2 meshes both with the loose wheel 5 and also with the loose wheel 21. By means of the clutch 9 for a forward gear, the loose wheel 21 can be connected to the fixed wheel 22 and the fixed wheel 23, whereas the fixed wheel 22 and the fixed wheel 23 are connected to the shaft 24 and the loose wheel 21 is mounted to rotate on the shaft 24. The fixed wheel 23 meshes with the fixed wheel 25, which is arranged in a rotationally fixed manner on the shaft 26. Mounted to rotate on the shaft 26 is the loose wheel 28, which can be connected by means of the first gear clutch 27 to the fixed wheel 25. The loose wheel 28 meshes with the fixed wheel 29, which is connected in a rotationally fixed manner to the shaft 30 on which the loose wheel 32 is mounted to rotate. By means of the third gear clutch 31, the fixed wheel 29 can be connected to the loose wheel 32. The loose wheel 32 meshes with the fixed wheel 18, which is connected in a rotationally fixed manner to the shaft 33 and can be connected by means of the second gear clutch 34 to the loose wheel 35 which is also arranged on the shaft 33.

Thus, by engaging the fourth gear clutch 15, the mechanical power path can be connected through and the hydrodynamic torque converter 1 therefore put out of function in that shift position, whereby the efficiency is improved considerably. Preferably, by engaging the fourth gear clutch 15 those gears can be engaged which are used for driving at higher speeds.

A first gear in the forward direction is engaged by actuating the clutch 9 for a forward gear and the first gear clutch 27 in the closing direction, whereby a first gear can be engaged by means of the hydrodynamic torque converter 1. A second gear is engaged by keeping the clutch 9 for the forward gear engaged and, instead of the first gear clutch 27, engaging the second gear clutch 34 by actuating it in the closing direction. This engages a second gear by way of the hydrodynamic torque converter 1. A third gear is engaged by keeping the clutch 9 for the forward gear engaged and also actuating the third gear clutch 31 in the closing direction. This enables a third gear to be engaged by way of the hydrodynamic torque converter 1. To engage a fourth gear in the forward driving direction, so that the vehicle is now in the higher speed range, the clutch 9 for the forward gear is actuated in the opening direction and the fourth gear clutch 15 is actuated in the closing direction. In addition, for this gear the first clutch 27 is actuated in the closing direction. This provides a gear, namely the fourth gear, without the hydrodynamic torque converter 1 and thus by direct drive by means of the drive engine. A fifth gear is engaged by keeping the fourth gear clutch 15 closed and actuating the second gear clutch 34 in the closing direction. This enables a fifth gear without the hydrodynamic torque converter 1. A sixth gear is engaged by keeping the fourth gear clutch 15 closed and actuating the third gear clutch 31 in the closing direction. Thus, at the top speed of the vehicle too a gear without the hydrodynamic torque converter 1 is enabled.

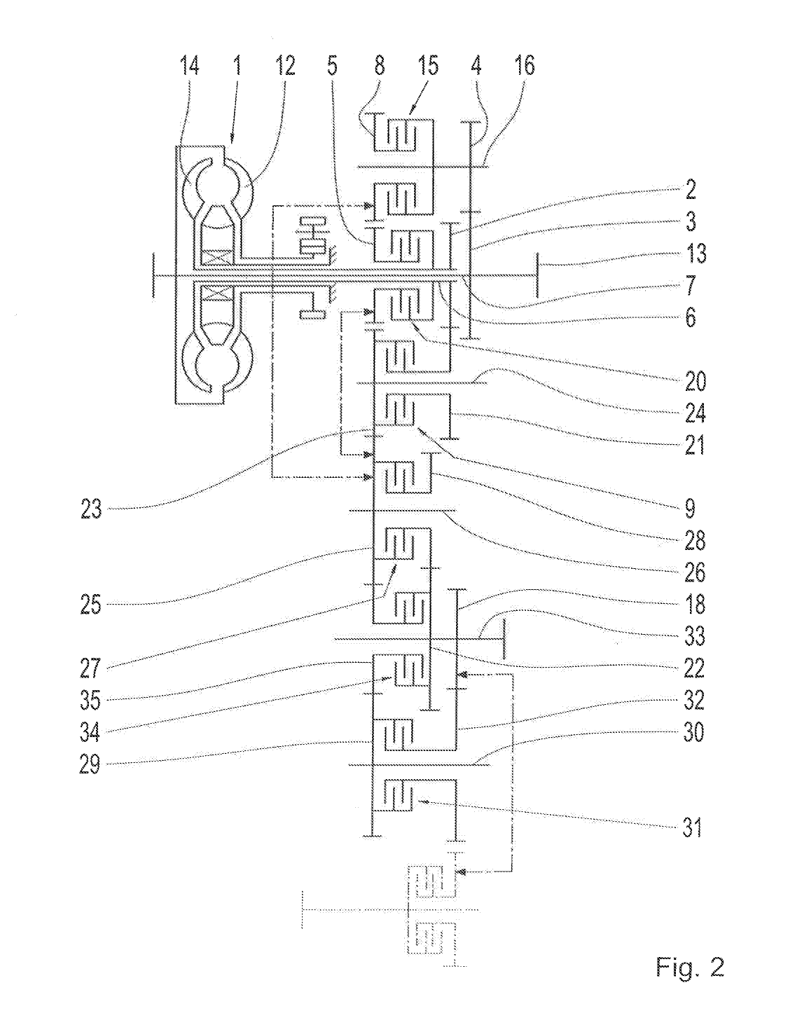

FIG. 2:

A drive engine (not shown), for example an internal combustion engine drives, on the one hand, the pump 12 of the hydrodynamic torque converter 1 and, on the other hand, the driveshaft 7, which is connected in a rotationally fixed manner to the fixed wheel 3 and which at the same time forms the drive input for the auxiliary power take-off 13. The turbine 14 is connected in a rotationally fixed manner to the input shaft 6, which is connected to the fixed wheel 2. The input shaft 6 can be connected by means of the clutch 20 for reverse driving to the loose wheel 5. The fixed wheel 2 meshes with the loose wheel 21, the fixed wheel 3 meshes with the fixed wheel 4 and the loose wheel 5 meshes with the fixed wheel 25. The fixed wheel 4 is connected in a rotationally fixed manner to the shaft 16 and can be connected by means of the fourth gear clutch 15 to the loose wheel 8. The loose wheel 8 meshes with the fixed wheel 25. The loose wheel 21 is mounted to rotate on the shaft 24 and can be connected by means of the clutch 9 for the forward gear to the fixed wheel 23. The fixed wheel 23 is connected in a rotationally fixed manner to the shaft 24. The fixed wheel 23 meshes with the fixed wheel 25, which is connected in a rotationally fixed manner to the shaft 26 and which can be connected by means of the first gear clutch 27 to the loose wheel 28. The loose wheel 28 meshes with the fixed wheel 22, which is connected rotationally fixed to the shaft 33 that forms the drive output. By means of the second gear clutch 34 the fixed wheel 22 can be connected to the loose wheel 35. Also connected in a rotationally fixed manner to the shaft 33 is the fixed wheel 18, which meshes with the loose wheel 32. The loose wheel 32 meshes with the fixed wheel 29, which is connected in a rotationally fixed manner to the shaft 30. By means of the third gear clutch 31 the fixed wheel 29 can be connected to the loose wheel 32.

Thus, the first three gears are engaged by way of the hydrodynamic torque converter 1 and gears four, five and six are engaged without the hydrodynamic torque converter 1, directly with the drive engine. The first gear in the forward direction is engaged by actuating the clutch 9 for the forward gear in the closing direction and likewise closing the first gear clutch 27. A second gear in the forward driving direction is engaged by keeping the clutch 9 for the forward gear closed and also closing the second gear clutch 34. A third gear in the forward driving direction is engaged by keeping the clutch 9 for the forward gear closed and also actuating the third gear clutch 31 in the closing direction. A fourth forward gear is engaged by actuating the clutch 9 for the forward gear in the opening direction and actuating the fourth gear clutch 15 in the closing direction and also the first gear clutch 27 in the closing direction. A fifth gear is engaged by actuating the fourth gear clutch 15 in the closing direction and also the second gear clutch 34 in the closing direction. A sixth gear is engaged by actuating the fourth gear clutch 15 in the closing direction and the third gear clutch 31 also in the closing direction.

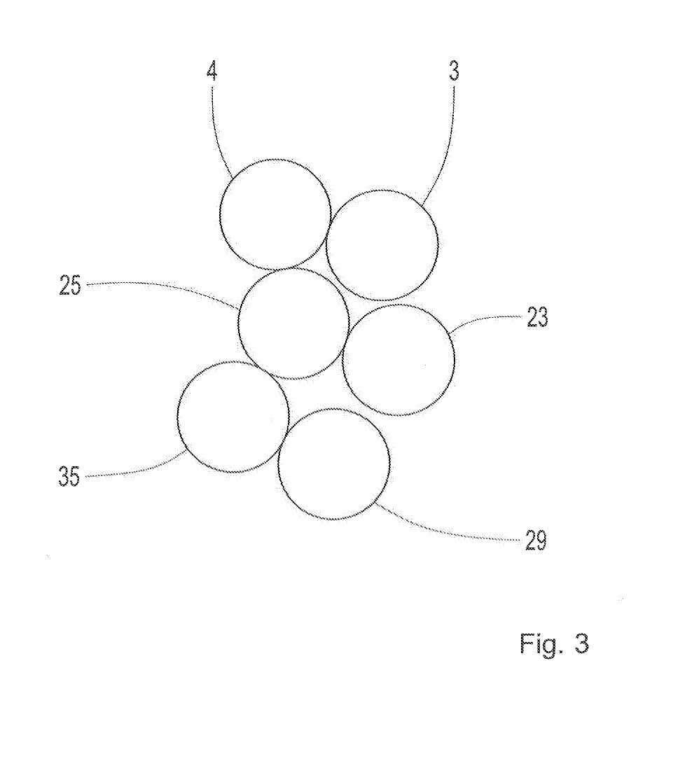

FIG. 3:

The arrangement of the gearwheels in the transmission layout according to FIG. 2 is shown.

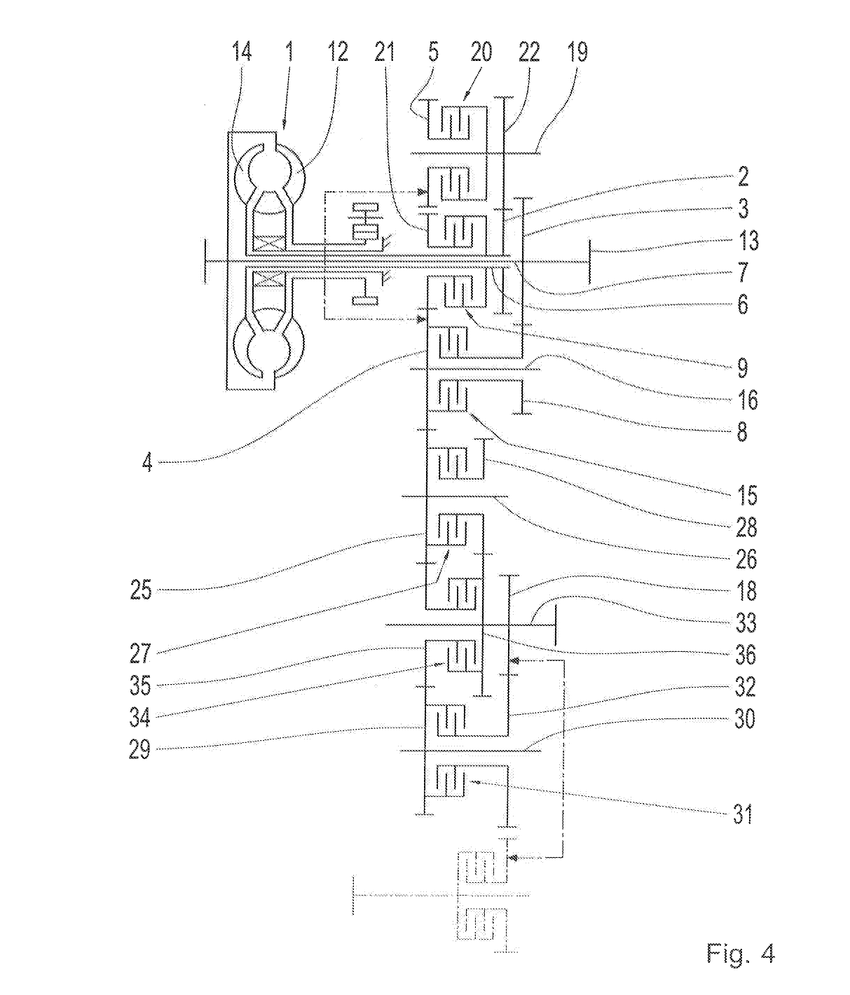

FIG. 4:

A drive engine (not shown) drives on the one hand the pump 12 of the hydrodynamic torque converter 1 and on the other hand the driveshaft 7, which is connected in a rotationally fixed manner to the fixed wheel 3 and which forms the drive output for the auxiliary power take-off 13. The turbine 14 is connected in a rotationally fixed manner to the input shaft 6, which is connected in a rotationally fixed manner to the fixed wheel 2. In addition, for a forward gear 9 the input shaft 6 can be connected to the loose wheel 21. The fixed wheel 2 meshes with the fixed wheel 22, which is connected in a rotationally fixed manner to the shaft 19 and can be connected to the loose wheel 5 by means of the reversing gear clutch 20. The loose wheel 5 meshes with the fixed wheel 4, which can be connected by means of the fourth gear clutch 15 to the loose wheel 8 that is arranged on the shaft 16. The loose wheel 21 also meshes with the fixed wheel 4, which in turn meshes with the fixed wheel 25. The fixed wheel 25 is arranged on the shaft 26 and can be connected by means of the first gear clutch 27 to the loose wheel 28. The fixed wheel 25 meshes with the loose wheel 35 and the loose wheel 28 meshes with the fixed wheel 36. The fixed wheel 36 is connected in a rotationally fixed manner to the shaft 33, which forms the drive output of the transmission. By means of the second gear clutch 34, the fixed wheel 36 can be connected to the loose wheel 35. The fixed wheel 18 is connected in a rotationally fixed manner to the shaft 33 and meshes with the loose wheel 32, which is arranged on the shaft 30. The loose wheel 32 can be connected to the fixed wheel 29 by means of the third gear clutch 31.

Thus, the first three gears of the transmission can be engaged by way of the hydrodynamic torque converter 1 and gears four, five and six can be engaged without the hydrodynamic torque converter 1. A first gear is engaged by actuating the clutch 9 for the forward gear in the closing direction and the first gear clutch 27 also in the closing direction. A second gear can be engaged by actuating the clutch 9 for the forward gear in the closing direction and the second gear clutch 34 also in the closing direction. A third gear can be engaged by actuating the clutch 9 for forward driving and the third gear clutch 31 in the closing direction. A fourth gear can be engaged without the hydrodynamic torque converter 1 by actuating the fourth gear clutch 15 in the closing direction and actuating the clutch 9 for the forward gear in the opening direction and the first gear clutch 27 in the closing direction. A fifth gear can be engaged by actuating the fourth gear clutch 15 and the second gear clutch 34, both in the closing direction. A sixth gear can be engaged by actuating the fourth gear clutch 15 and the third gear clutch 31 in the closing direction. Thus, at higher speeds the transmission is shifted without the hydrodynamic torque converter 1.

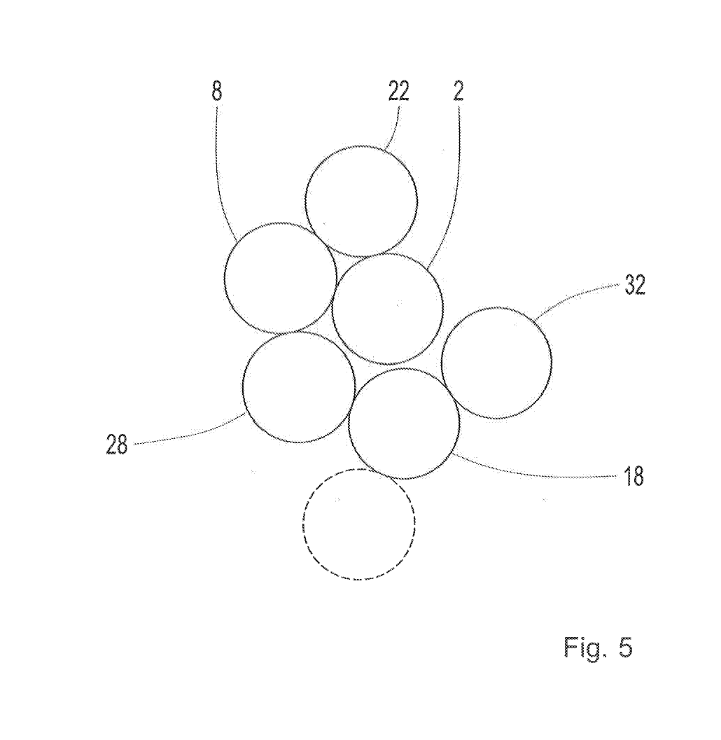

FIG. 5:

The arrangement of the gearwheels in the transmission layout according to FIG. 4 is shown in FIG. 5.

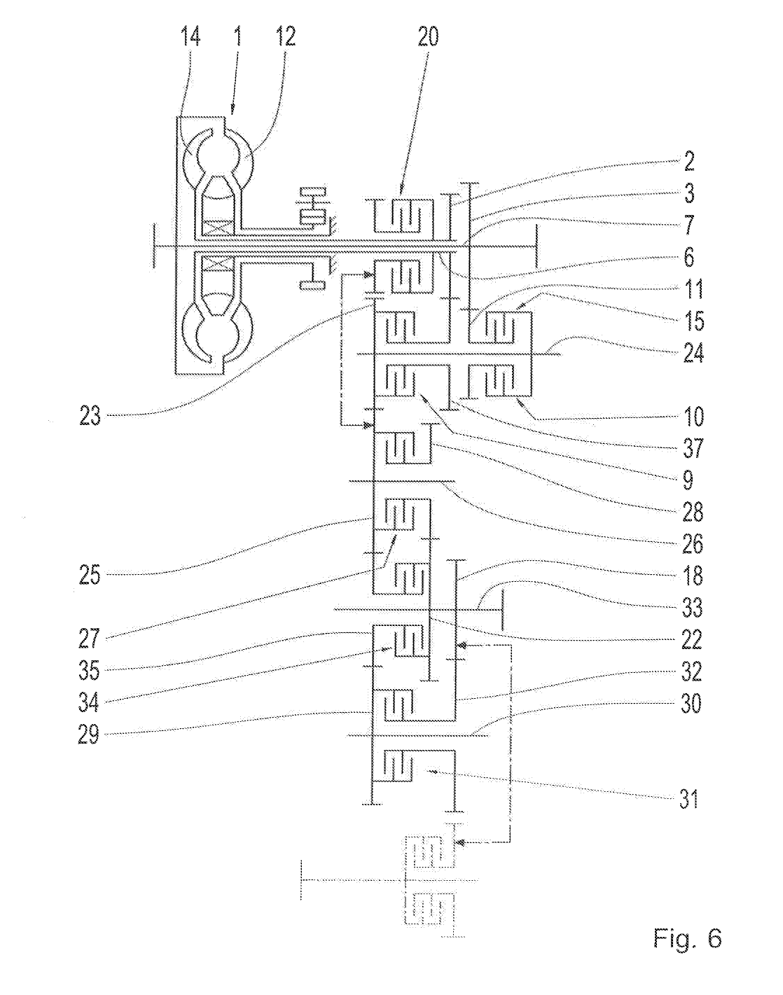

FIG. 6:

In contrast to the transmission layouts according to FIGS. 1, 2 and 4, in the transmission layout according to FIG. 6 it is not the case that only a single clutch is arranged on a shaft, but rather, two clutches are arranged on a shaft. On the shaft 24 are arranged both the clutch 9 for the forward gear and the fourth gear clutch 15. The fourth gear clutch 15 can also be regarded as the clutch for a further forward gear. The input shaft 6 and the fixed wheel 2 are connected to the turbine 14, whereas the fixed wheel 3 is connected to the driveshaft 7 and thus also to the drive engine (not shown), which also drives the pump 12. The fixed wheel 2 meshes with the loose wheel 37 and the fixed wheel 3 meshes with the loose wheel 11, both of which are arranged on the shaft 24. The clutch 9 for the forward gear is arranged on the shaft 24 and the fourth gear clutch 15 is also arranged on the shaft 24. By means of the clutch for forward driving the loose wheel 37 can be connected to the eighth fixed wheel 23, and by means of the fourth gear clutch 15 the loose wheel 11 can be connected to the shaft 24 and thus to the fixed wheel 23. The fixed wheel 23 meshes with the fixed wheel 25, which can be connected by means of the first gear clutch 27 to the loose wheel 28. The shaft 33 forms the drive output and is connected in a rotationally fixed manner to the fixed wheel 18 and to the fixed wheel 22, whereas the loose wheel 35 can be connected by means of the second gear clutch 34 to the shaft 33. The third gear clutch 31 is arranged on the shaft 30, whereby the fixed wheel 29 can be connected to the loose wheel 32.

Thus, the first three gears of the transmission can be engaged by way of the hydrodynamic torque converter 1 and gears four, five and six can be engaged without the hydrodynamic torque converter 1. A first gear is engaged by actuating the clutch 9 for a forward gear and the first gear clutch 27, both in the closing direction. A second gear is engaged by keeping the clutch 9 for the forward gear closed and also actuating the second gear in the closing direction. The clutch for the third gear is engaged by keeping the clutch 9 for the forward gear closed and also actuating the third gear clutch 31 in the closing direction. A fourth gear without the hydrodynamic torque converter 1 is engaged by actuating the clutch 9 for the forward gear in the opening direction and the fourth gear clutch 15 in the closing direction, as well as the first gear clutch 27 in the closing direction. A fifth gear can be engaged by actuating the fourth gear clutch 15 and the second gear clutch 34, both in the closing direction. A sixth gear can be engaged by actuating the fourth gear clutch 15 and the third gear clutch 31, both in the closing direction. The reversing gears can be engaged by actuating the clutch 20 for reverse driving in the closing direction. This is arranged on the input shaft 6.

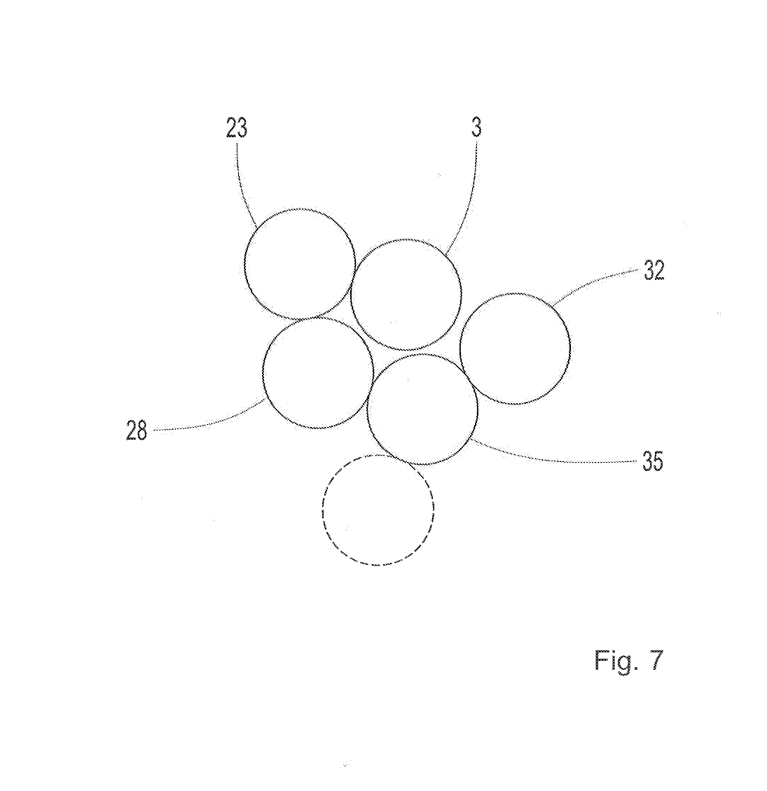

FIG. 7:

The arrangement of the gearwheels of the transmission layout according to FIG. 6 is shown in FIG. 7.

### INDEXES

1 Hydrodynamic torque converter
2 Fixed wheel
3 Fixed wheel
4 Fixed wheel
5 Loose wheel
6 Input shaft
7 Driveshaft
8 Loose wheel
9 Clutch for a forward gear
10 Clutch for a further forward gear
11 Loose wheel
12 Pump
13 Auxiliary power take-off
14 Turbine
15 Fourth gear clutch
16 Shaft
17 Fixed wheel
18 Fixed wheel
19 Shaft
20 Clutch for the reverse gear, or reverse gear clutch
21 Loose wheel
22 Fixed wheel
23 Fixed wheel
24 Shaft
25 Fixed wheel
26 Shaft
27 First gear clutch
28 Loose wheel
29 Fixed wheel
30 Shaft
31 Third gear clutch
32 Loose wheel
33 Shaft
34 Second gear clutch
35 Loose wheel
36 Fixed wheel
37 Loose wheel
38 Shaft

1-8. (canceled)

9. A powershift transmission for a construction machine, the powershift transmission comprising:
a hydrodynamic torque converter (1) having a turbine (14) and a pump (12),
the pump (12) being connected, in a rotationally fixed manner, with a driveshaft (7) and the turbine (14) being connected, in a rotationally fixed manner, with an input shaft (6),
the input shaft (6) being directly connected, in a rotationally fixed manner, to a first fixed wheel (2),
the input shaft (6) being a hollow shaft and the driveshaft (7) being arranged inside the hollow shaft (6),
the driveshaft (7) being directly connected, in a rotationally fixed manner, to a second fixed wheel (3),
the first fixed wheel (2) being arranged coaxially with the second fixed wheel (3), and
the first fixed wheel (2) meshing with either a third fixed wheel or a first loose wheel and the second fixed wheel (3) meshing with either a fourth fixed wheel or a second loose wheel.

10. The powershift transmission according to claim 9, wherein the first fixed wheel (2) is arranged between the hydrodynamic torque converter (1) and the second fixed wheel (3), and the second fixed wheel (3) is connected, in a rotationally fixed manner, to an auxiliary power take-off.

11. The powershift transmission according to claim 9, wherein the first fixed wheel (2) is functionally connected with the third fixed wheel (22) so that the third fixed wheel (22) is arranged coaxially with a reversing clutch (20) for a reversing gear and is connected in a rotationally fixed manner to the reversing clutch (20), and the second fixed wheel (3) is functionally connected with the second loose wheel (8) so that the second loose wheel (8) is arranged coaxially with a clutch (15) for a fourth gear and is connected in a rotationally fixed manner to the clutch (15) for the fourth gear, and the input shaft (6) is connected, in a rotationally fixed manner, to a clutch (9) for a forward gear and the clutch (9) for the forward gear is arranged coaxially with the input shaft (6).

12. The powershift transmission according to claim 9, wherein the second fixed wheel (3) is functionally connected with the fourth fixed wheel (4) so that the fourth fixed wheel (4) is arranged coaxially with a clutch (15) for a fourth gear and is connected, in a rotationally fixed manner, to the clutch for the fourth gear, and the first fixed wheel (2) is functionally connected to the first loose wheel (21) so that the first loose wheel (21) is arranged coaxially with a clutch (9) for a forward gear and is connected in a rotationally fixed manner to the clutch (9) for the forward gear, and the input shaft (6) is connected, in a rotationally fixed manner, to a reversing clutch (20) for driving in reverse and the reversing clutch is arranged coaxially with the input shaft (6).

13. The powershift transmission according to claim 9, wherein the first fixed wheel (2) is functionally connected with the first loose wheel (5) so that the first loose wheel (5) is arranged coaxially with a reversing clutch (20) for a reversing gear and is connected in a rotationally fixed manner to the reversing clutch, and the second fixed wheel (3) is functionally connected with the second loose wheel (8) so that the second loose wheel (8) is arranged coaxially with a clutch (15) for a fourth gear and is connected in a rotationally fixed manner to the clutch for the fourth gear, and the input shaft (6) is not directly connected to any clutch.

14. The powershift transmission according to claim 9, wherein the first fixed wheel (2) is functionally connected with the first loose wheel (37) so that the first loose wheel (37) is arranged coaxially with a clutch (9) for a forward gear and is connected in a rotationally fixed manner to the clutch (9) for the forward gear, and the second fixed wheel (3) is functionally connected with the second loose wheel (11), the second loose wheel (11) being arranged coaxially with a clutch (15) for another forward gear and being connected, in a rotationally fixed manner, to the clutch for another forward gear, and the first loose wheel (37), the second loose wheel (11), the clutch (9) for the forward gear and the clutch (15) for the another forward gear are all arranged coaxially with one another.

15. The powershift according to claim 11, wherein the powershift transmission comprises shafts (16, 19, 24, 26, 30, 33) with other clutches (9, 20, 27, 31, 34) and gearwheels so that the shafts are arranged spaced away from the input shaft (6) and only a single one of the other clutches (9, 20, 27, 31, 34) is arranged on each one of the shafts (16, 19, 24, 26, 30, 33).

16. The powershift transmission according to claim 14, wherein the powershift transmission comprises shafts (24, 26, 30, 33) with further clutches and gearwheels so that the shafts (24, 26, 30, 33) are arranged spaced away from the input shaft and, except for a first one of the shafts (24) on which the clutch (9) for the forward gear and the clutch (15) for the other forward gear are arranged, only a single one of the further clutches (27, 34, 31) is arranged on each of the shafts (26, 30, 33).
